(19) United States
(12) Patent Application Publication
(10) Pub. No.: US 2003/0009570 A1
(43) Pub. Date: Jan. 9, 2003

(54) Method and apparatus for segmented peer-to-peer computing

(75) Inventors: Paul Andrew Moskowitz, Yorktown Heights, NY (US); William Grey, Millwood, NY (US); Clifford A. Pickover, Yorktown Heights, NY (US); Stephen J. Boies, Mahopac, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/898,613

(22) Filed: Jul. 3, 2001

(51) Int. Cl. G06F 15/16

(52) U.S. Cl. 709/229; 709/203

(57) ABSTRACT

A method, apparatus, and computer implemented instructions for managing processing of data in data processing system within a peer-to-peer network data processing system. A request is received from a requester. Preferences are compared within the request to control information to form a comparison, in which the control information dictates responses by the data processing system. The request is selectively responded to based on comparison.

### BACKGROUND OF THE INVENTION

1. Technical Field

The present invention relates generally to an improved data processing system, and in particular to a method and apparatus for processing data. Still more particularly, the present invention provides a method, apparatus, and computer implemented instructions for peer-to-peer computing.

2. Description of Related Art

The Internet, also referred to as an “internetwork”, is a set of computer networks, possibly dissimilar, joined together by means of gateways that handle data transfer and the conversion of messages from a protocol of the sending network to a protocol used by the receiving network. When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

The standard computing structure on the Web is that of a classic client-server network. Requests for information are sent from clients to a server. The server, in turn, processes the request and returns a reply, which may be a Web page or a file. A newer architecture used on the Web is a peer-to-peer network. A peer-to-peer network is a communications network that allows all workstations and computers in the network to act as servers to all other users on the network. Dedicated file servers may be used, but are not required as in a client/server architecture. This type of network architecture does not solve a problem in which two or more distinct groups of users desire to transfer information or communicate only with those outside of their group. For example, with job seekers and employers, many job seekers only want to communicate with employers and not other job seekers. Similarly, employers desire to communicate with job seekers and not other employers.

Therefore, it would be advantageous to have an improved method and apparatus for managing communications within a peer-to-peer network data processing system.

### SUMMARY OF THE INVENTION

The present invention provides a method, apparatus, and computer implemented instructions for managing processing of data in data processing system within a peer-to-peer network data processing system. A request is received from a requestor. Preferences are compared within the request to control information to form a comparison, in which the control information dictates responses by the data processing system. The request is selectively responded to based on comparison.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram illustrating a data processing system in which the present invention may be implemented;

FIG. 3 is a diagram of a peer-to-peer network data processing system in accordance with a preferred embodiment of the present invention;

FIG. 4 is a diagram of components used for peer-to-peer computing in accordance with a preferred embodiment of the present invention;

FIG. 5 is a diagram illustrating a request from a node in a peer-to-peer network data processing system in accordance with a preferred embodiment of the present invention;

FIGS. 6A and 6B are diagrams illustrating a profile and a request in accordance with a preferred embodiment of the present invention;

FIG. 7 is a flowchart of a process used for generating a request in a peer-to-peer network data processing system in accordance with a preferred embodiment of the present invention;

FIG. 8 is a flowchart of a process used for processing a request in a peer-to-peer network data processing system in accordance with a preferred embodiment of the present invention;

FIG. 9 is a flowchart of a process used for changing membership in a group in a peer-to-peer network data processing system in accordance with a preferred embodiment of the present invention; and

FIG. 10 is a flowchart of a process used for reviewing membership in a group in accordance with a preferred embodiment of the present invention.

### DETAILED DESCRIPTION OF THE PREFERRED EMBODIMENT

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables. Network data processing system 100 may support both client/server and peer-to-peer computing systems.

In the depicted example, work station 104 is connected to network 102 along with storage unit 106. In addition, work stations 108, 110, and 112 are connected to network 102. These work stations also are referred to as nodes, These work stations 108, 110, and 112 may be, for example, personal computers or network computers. In the depicted example, these data processing system communicate with each other in a peer-to-peer fashion. The present invention provides a method, apparatus, and computer implemented instructions for in which these work stations are able facilitate communications between two or more groups of nodes in which a node in a group desires to communicate only with nodes outside of the group to which the node belongs. For example, with job seekers and employers, job seeker nodes do not communicate with them selves, but only with communicate with employer nodes. The mechanism for enabling this feature is described in more detail below.

Network data processing system 100 may include servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN).

In an additional example, data processing system 100 may be implemented as or include a wireless network. For example, a Bluetooth wireless network may be used in the peer-to-peer computing system of the present invention. Bluetooth is a wireless personal area network (PAN) technology from the Bluetooth Special Interest Group. Bluetooth is an open standard for short-range transmission of digital voice and data between mobile devices (laptops, PDAs, phones) and desktop devices. Bluetooth supports point-to-point and multipoint applications. A Bluetooth radio is built into a small microchip and operates in a globally available frequency band ensuring communication compatibility worldwide. A tiny Bluetooth microchip, incorporating a radio transceiver, is built into digital devices. Bluetooth technology makes all connections quickly and without the need for cable. The radio operates in a globally available frequency band, ensuring compatibility worldwide. Bluetooth facilitates fast and secure transmission of both voice and data, even when the devices are not within line of sight. Bluetooth technology supports both point-to-point and point-to-multipoint connections. Bluetooth has a nominal link range is up to 10 meters.

Currently, up to seven ‘slave’ devices can be set to communicate with a ‘master’ radio in one device. Several of these ‘piconets’ can be established and linked together in ad hoc ‘scatternets’ to allow communication among continually flexible configurations. All devices in the same piconet have priority synchronization, but other devices can be set to enter at any time. The topology can best be described as a flexible, multiple piconet structure. FIG. 1 is intended as an example, and not as an architectural limitation for the present invention.

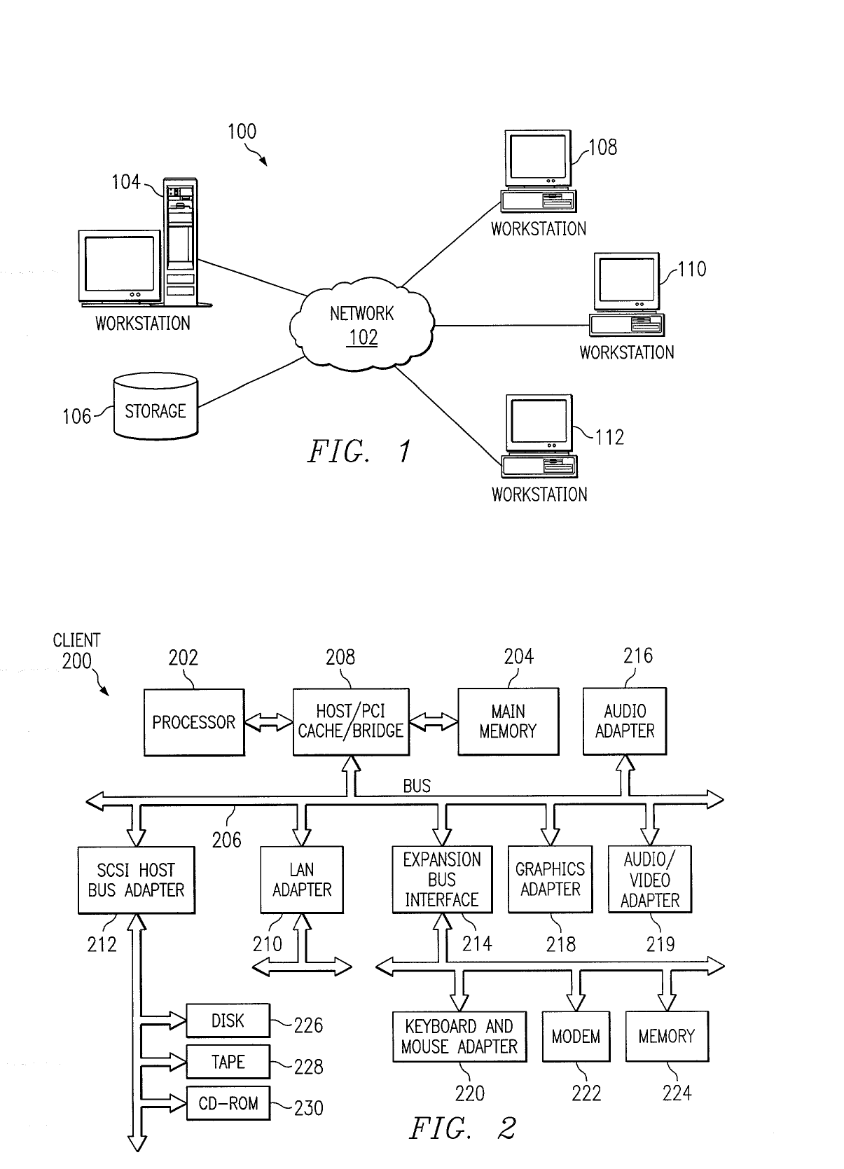

With reference now to FIG. 2, a block diagram illustrating a data processing system is depicted in which the present invention may be implemented. Data processing system 200 is an example of a node, such as, for example, work station 104 in FIG. 1. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. Small computer system interface (SCSI) host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

As another example, data processing system 200 may be a stand-alone system configured to be bootable without relying on some type of network communication interface, whether or not data processing system 200 comprises some type of network communication interface. As a further example, data processing system 200 may be a Personal Digital Assistant (PDA) device, which is configured with ROM and/or flash ROM in order to provide nonvolatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

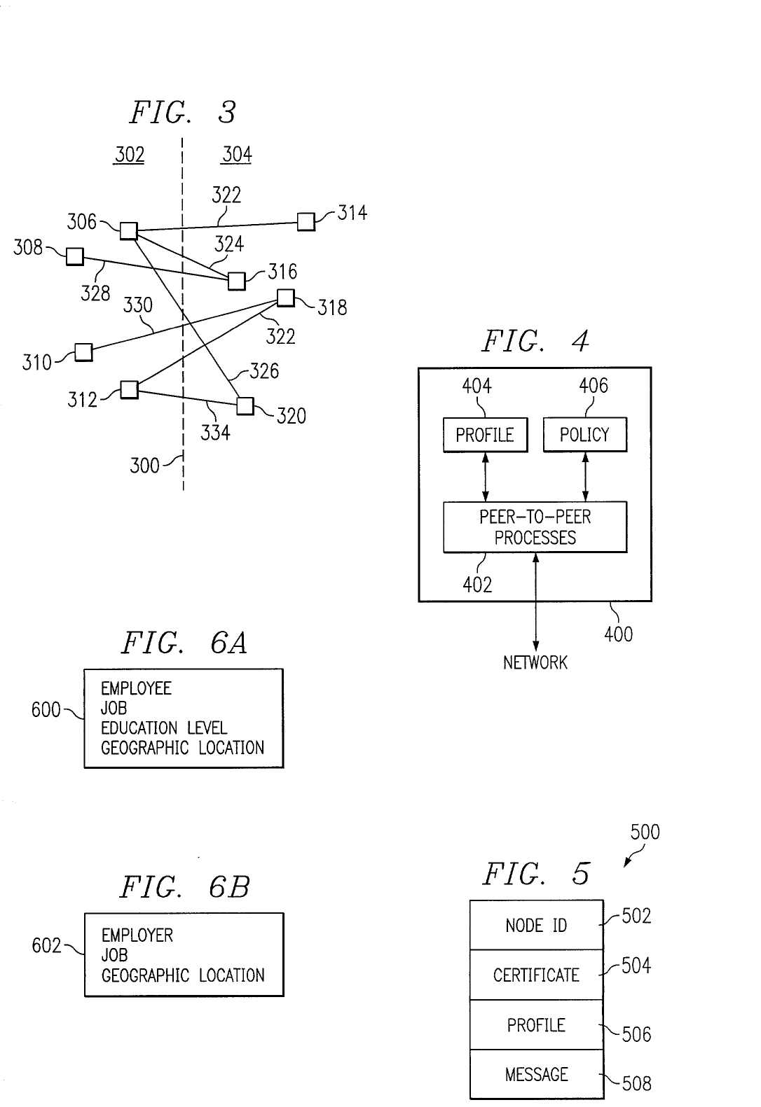

With reference now to FIG. 3, a diagram of a peer-to-peer network data processing system is depicted in accordance with a preferred embodiment of the present invention. Peer-to-peer network data processing system 300 may be implemented within network data processing system 100 in FIG. 1. In this example, two groups of nodes are illustrated, group 302 and group 304. Group 302 contains nodes 306, 308, 310, and 312, while group 304 contains nodes 314, 316, 318, and 320. Node 306 includes communications link 322 to node 314, communications link 324 to node 316, and communications link 326 to node 320. Node 308 has communications link 328 to node 316. Node 310 includes communications link 330 to node 318. Node 312 includes communications link 332 to node 318 and communications link 334 to node 320.

As, can be seen in this example, nodes within group 302 only establish communications links with nodes in group 304. No communications links are present between nodes within the same group. Only two groups are shown in this example for purposes of illustrating the communications between members within a group to members in another group. This type of connection may be applied to other numbers of groups and other numbers of nodes other than those illustrated in FIG. 3. For example, a peer-to-peer network data processing system may include three groups of nodes: group 1, group 2, and group 3. The nodes in group 1 may communicate only with the nodes in group 2, and the nodes in group 3 may only communicate with the nodes in group 1. In this example, the nodes in group 2 do not communicate with nodes in group 3 or with nodes in group 1.

The establishment of communications links between nodes are governed using a policy in these examples. The policy is a set of rules, which dictate communications with other nodes. All nodes may receive messages broadcast from a first node. Only selected nodes may reply based on the policy implemented at each node.

Turning next to FIG. 4, a diagram of components used for peer-to-peer computing is depicted in accordance with a preferred embodiment of the present invention. Node 400 may be implemented using data processing system 200 in FIG. 2. Node 400 includes peer-to-peer processes 402, which provide the processes used to generate requests and to handle received requests. These processes may be performed on a node in the peer-to-peer network or may be performed on a separate central processing system associated with the peer-to-peer network that is in communication with the nodes of the network. The processing of requests is performed using information in profile 404 and policy 406. Profile 404 includes information about the user. Profile 404 may be defined as a set of user preferences. This information may include, for example, dating/social interaction preferences, applicant vs. employer, music or other media preferences, particular expertise, ownership characteristics, interest, geographical location, membership in organization or affinity groups, consumption preferences and purchasing histories, and expertise. This profile information may be used to establish membership in different groups.

Policy 406 provides rules and other information used to determine whether peer-to-peer processes 402 will respond to a request. Policy 406 forms the control information used to determine how a request is to be handled. For example, a job seeker node may receive a request from an employer node looking for job seekers. Although the job seeker node needs the requirements in the response, a response may not be generated if, for example, a match in geographic location for the job is absent. In this case, the request is discarded without a response. Policy 406 also is used to determine whether a node can interact only with members of the same set, only with members not of the same set, or members of different sets. Policy 406 also may contain certificate for use in verifying membership within a group. A certificate is the digital equivalent of an ID card used in conjunction with a public key encryption system. Certificate also are called “digital IDs”. Typically, digital certificates are issued by trusted third parties known as certification authorities after verifying that a public key belongs to a certain owner. The certification process varies depending on the certification authorities and the level of certification. Drivers licenses, notarization and fingerprints are examples of documentation required. The digital certificate is actually the owner's public key that has been digitally signed by the certification authorities. The digital certificate is sent along with an encrypted message to verify that the sender is truly the entity identifying itself in the transmission. The recipient uses the public key of the certification authorities, which is widely publicized, to decrypt the sender's public key attached to the message. Then the sender's public key is used to decrypt the actual message.

Access or verification of a node may be controlled using other mechanisms, such as a password. Membership within a group and access to nodes within the group also could be based on a payment of money or services.

The duration of membership within a group may be permanent or temporary. If temporary, the membership may continue only for a selected period of time or as long as attributes of the user fall within certain values or ranges. These attributes may include, for example, martial status, age, interests, geographic location, and consumption preferences. Membership also may be based on contributions or usage of the peer-to-peer network data processing system.

The interaction between different nodes may be based on services, such as a dating service; an information sharing service; an employment service; a group buying server; and a service for sharing music, books, articles, images, or other media. The interaction between nodes may include various activities, such as, for example, chatting, instant messaging, and e-mail. The interaction also may include an information sharing service, a group buying service, instant messaging, electronic mail, distributing software, distributing software upgrades, or distributing software fixes. This interaction also may include a distribution of intellectual property, such as copyrighted or patented materials. Members in a group may exchange compensation for different interactions. This compensation may take various forms, such as financial, barter, or payment in kind. The compensation may be based on attributes of the interactions, such as, for example, a size of files transferred, a quality of a good, a quality of a service, a type of good, a type of server, and a member rating.

In one example, the management of payments between different members may be performed using a clearinghouse. The clearinghouse may be, for example, a Web site designed for the exchange of payments. PayPal of Palo Alt, Calif., found on the Internet at www.paypal.com, is an example of a clearinghouse.

Turning next to FIG. 5, a diagram illustrating a request from node in a peer-to-peer network data processing system is depicted in accordance with a preferred embodiment of the present invention. This example, request 500 includes node ID 502, certificate 504, profile 506 (i.e., a set of user preferences), and message 508. Node ID 502 is typically found within a header of request 500 but also may be located elsewhere depending on the particular implementation. Node ID 502 may include an IP address of the node, a user name, or some unique identifier. Certificate 504 is used to verify the identity of an individual or user at the node. Certificate 504 may be associated with an IP address, an e-mail address, or some other unique identifier. Profile 506 contains information about the user at the node. This information is used by a node receiving the request to determine whether to respond to the request.

Next, message 508 contains the particular request being may be the node. This request may include, for example, requesting initiation of a chat session, requesting a resume, requesting a video file, or requesting a document. Message 508 also may identify what groups should respond to the request. For example, the request may ask for employers seeking employees to respond.

When request 500 is received by a node, the peer-to-peer process in the node will determine how the request is handled. Turning now to FIGS. 6A and 6B, diagrams illustrating a profile and a request are depicted in accordance with a preferred embodiment of the present invention. Profile 600 in FIG. 6A is an example of user preference information that may be included in profile 506 in FIG. 5. Profile 600 identifies the user as an employee having a particular job, education level, and geographic location. In FIG. 6B, request 602 is an example of a request that may be found with message 508 in FIG. 5. Request 602 indicates that the user is requesting a response from an employer for a job with a particular geographic location. The employer may be any employer or be specified as a particular type of employer depending on the implementation. The profile and request shown in FIGS. 6A and 6B are presented for purposes of illustration and are not intended to limit the amount or type of information that may be used.

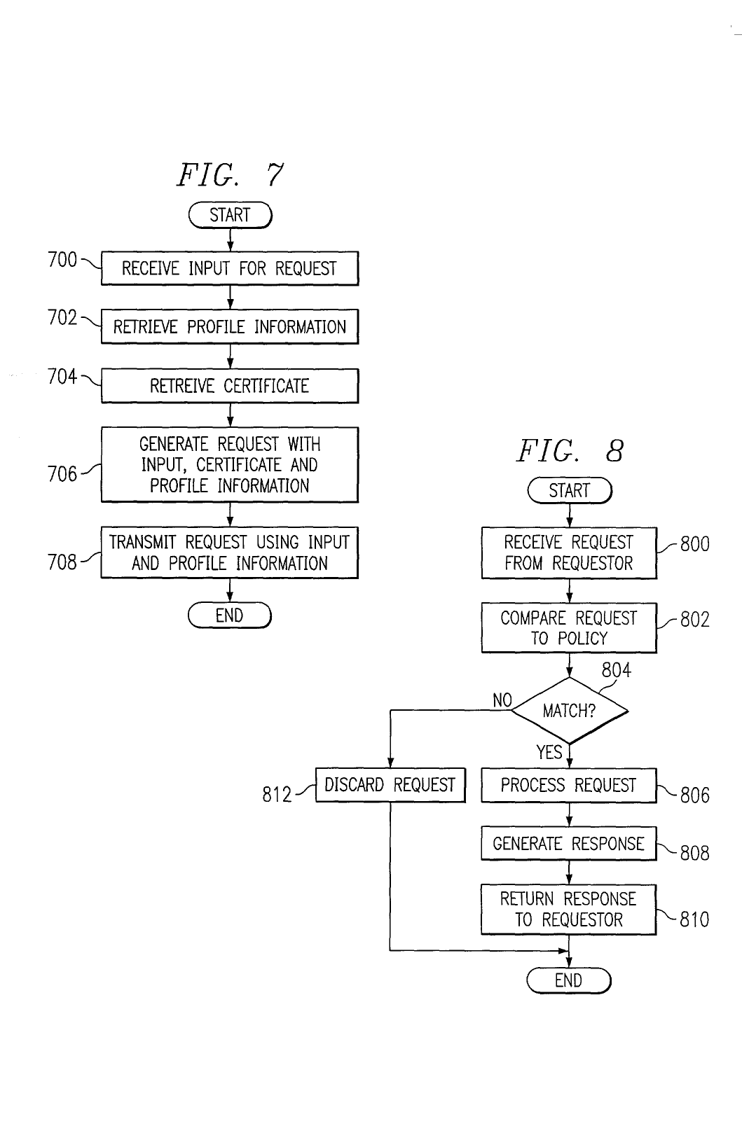

Turning now to FIG. 7, a flowchart of a process used for generating a request in a peer-to-peer network data processing system is depicted in accordance with a preferred embodiment of the present invention. The process illustrated in FIG. 7 may be implemented in a data processing system, such as node 400 in FIG. 4.

The process begins by receiving input for a request from a user (step 700). Next, profile information is received (step 702). Thereafter, a certificate is retrieved (step 704. The certificate is used to authenticate the identity of the user generating the request at the node. A request is generated with the input, certificate, and profile information (step 706). This request may take the form of request 500 in FIG. 5. Then, the request is transmitted using the input and profile information (step 708) with the process terminating thereafter.

With reference now to FIG. 8, a flowchart of a process used for processing a request in a peer-to-peer network data processing system is depicted in accordance with a preferred embodiment of the present invention. The process illustrated in FIG. 8 may be implemented in a data processing system, such as node 400 in FIG. 4.

The process begins by receiving a request from a requestor (step 800). Next, the request is compared to a policy (step 802). A determination is then made as to whether a match is present (step 804). This step may include determining whether the profile information within the request identifies that the requesting node as being a member of a group for which communication is permitted. For example, employers are permitted to communicate with job applicants (employees). Alternatively, the step may include determining that the profile information within the request identifies the requesting node as being a member of a group for which communication is not permitted. For example, employers may not be permitted to communicate with other employers. Additionally, step 804 may include determining whether the node meets the parameters of the request if the requesting node is one in which communications is permitted. For example, the requesting node may be a job seeker seeking an employer having a management job. The node receiving the request may be an employer seeking a job seeker for a programming job. In this instance, the node sending the request is a member of a group in which communications is allowed, but no response is made because the parameter in the request, a management position, is not available.

If a match is present, the request is processed (step 806). A response is generated (step 808). The response is then returned to the requestor (step 810) with the process terminating thereafter. Turning back to step 804, if no match is present, the request is discarded (step 812) and the process terminates.

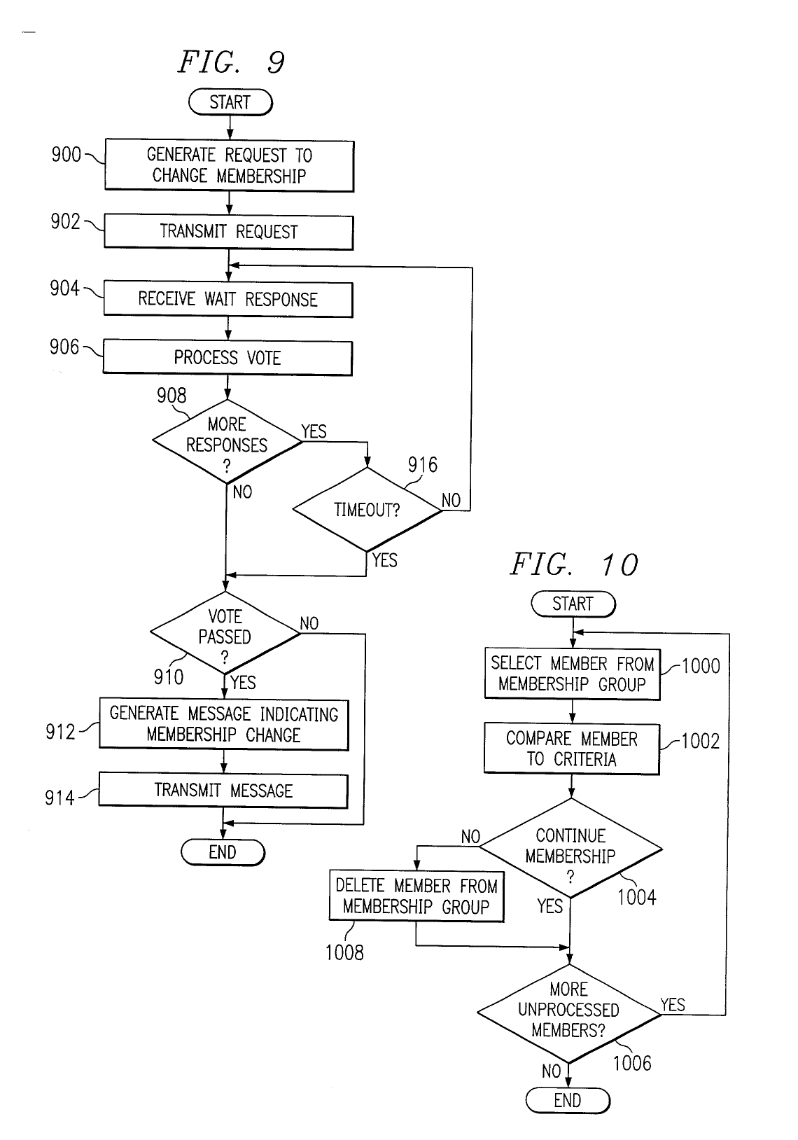

Turning now to FIG. 9, a flowchart of a process used for changing membership in a group in a peer-to-peer network data processing system is depicted in accordance with a preferred embodiment of the present invention. The process illustrated in FIG. 9 may be implemented in data processing system, such as node 400 in FIG. 4. Through the process illustrated in FIG. 9, a member of a group may initiate a vote to include or authorize a new member in the group. Further, a member of the group may vote to exclude a member of the same group or a different group.

The process begins by generating a request to change membership (step 900). Next, the request is transmitted to nodes within the peer-to-peer network data processing system (step 902). In these example, the message is broadcast within the network and those nodes within the network, which are part of the group, will process the request. Other nodes will ignore the request. The node originating the request waits to receive a response (step 904). The node originating the request will serve as a point to process responses. When a response containing a vote is received, the vote is processed (step 906). A determination is then made as to whether more responses are expected (step 908). This may be accomplished by establishing a timeout period for the responses. If no more responses are expected, a determination is made as to whether the vote is passed (step 910). If the vote does not pass, the process terminates. Otherwise, a message is generated indicating the membership change (step 912) and a message is transmitted to announce the change in membership within in the group (step 914) with the process terminating thereafter.

With reference again to step 908 if more responses are expected, a determination is made as to whether a timeout has occurred (step 916). The timeout is used to end voting and is selected as a period of time during which votes should be received. If a timeout has occurred, the process proceeds to step 910. If no timeout has occurred, the process returns to step 904 as described above.

Turning now to FIG. 10, a flowchart of a process used for reviewing membership in a group is depicted in accordance with a preferred embodiment of the present invention. The process illustrated in FIG. 10 may be implemented in data processing system, such as node 400 in FIG. 4. The process in FIG. 10 is implemented when nodes track members within a group. Nodes may track members by updating, exchanging, and storing membership lists.

The process begins by selecting a member from a membership group (step 1000). The member is compared to criteria (step 1002). Next, a determination is made as to whether the member should have continued membership (step 1004). If the membership is to be continued, a determination is made as to whether more unprocessed members are present (step 1006). If there are more unprocessed members are present, the process returns to step 1000 as described above. Otherwise, the process terminates. With reference again to step 1004, if the membership of the member is not to continue, the member is deleted from the membership group (step 1008) and the process proceeds to step 1006.

The duration of membership within the group may be unlimited. Typically, however, the criteria for membership may be based upon different factors, such as, for example, receipt of a payment from a member, a presence of selected attributes, contributions to the peer-to-peer data processing system, and usage of the peer-to-peer data processing system. The selected attributes may include, for example, marital status, age, and interests. Further, the interaction between members in a group may include exchanging compensation for the interactions. These interactions may include, for example, distribution of software, software fixes, and software upgrades. The compensation may take various forms, such as financial, barter, or payment in kind. Payments may be based on various attributes of the interactions, such as size of files transferred, quality of goods or services, type of good or service, and member ratings. The member ratings may be generated using various mechanisms. For example, the ratings may be based on feedback from set members, or from members of other sets. The ratings may be provided by a third party. Alternatively, the ratings may be based on analysis of interactions by group members, including, for example, financial size of transactions and number of successfully completed transactions. For example, Amazon.com assigns ratings to products based upon reviews provided by users (members) of the Amazon.com Web site. Additionally, the reviewers (members) are assigned ratings by the Web site based upon other members opinions of the usefulness of the reviews. Such member ratings may be included in profile (preference) information of the members.

Further, the mechanism of the present invention may be used for other purposes in which communications between nodes are based on policies. For example, advertising, information or marketing materials may be sent to different nodes based on characteristics of the group. When payments are exchanged, a clearinghouse may be used to manage payments between members in a group. This clearinghouse may be located in a node that is part of the group or in some other group. Compensation may be collected for intellectual property distributed through the network. For example, a clearinghouse may be used to collect royalties for copyrighted music. In this scheme, the clearinghouse may also receive compensation for managing collections and payments.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. Although the depicted illustrations show the mechanism of the present invention embodied on a single server, this mechanism may be distributed through multiple data processing systems. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system within a peer-to-peer network managing processing of requests, the method comprising:
receiving a request from a requestor;
comparing preferences within the request to a policy to form a comparison, wherein the policy controls responses by the data processing system to the requests; and
selectively responding to the request based on comparison.

2. The method of claim 1, wherein the data processing system is a node in the peer-to-peer network.

3. The method of claim 1, wherein the data processing system is a central processing system in the peer-to-peer network.

4. The method of claim 1, wherein the preferences provide parameters for which a response is desired.

5. The method of claim 1, wherein the preferences provide parameters for which a response is not desired.

6. The method of claim 1, wherein the requestor is an employee seeking to contact an employer.

7. The method of claim 6, wherein the data processing system responds to the request if the preference information for the data processing system indicates that the data processing system is associated with an employer.

8. The method of claim 1 , wherein the preferences identify a group associated with the requester and wherein the policy allows only interaction with members of a same group.

9. The method of claim 1, wherein the preferences identify a group associated with the requester and wherein the policy allows only interaction with members of a different group.

10. The method of claim 1, wherein the preferences identify a group associated with the requester and wherein the policy allows only interaction with members of selected groups of members.

11. The method of claim 1, wherein the requestor is a member of a group.

12. The method of claim 11, wherein groups are based upon at least one of social interaction preferences, dating preferences, music preferences, media preferences, skills of a member, interest, geographic location, membership in an organization, consumption preferences, purchasing history, and expertise.

13. The method of claim 11, wherein membership in the group is based on payment.

14. The method of claim 1 further comprising:
generating an outgoing request, wherein the outgoing request includes a request for one of a chat session, instant messaging, or e-mail message.

15. The method of claim 1, wherein the request is for interaction with one of a dating service, an information sharing service, a group buying service, instant messaging, electronic mail, distributing software, distributing software upgrades, distributing software fixes, an employment service, a music sharing service, a book sharing service, an image sharing service, and a travel service.

16. The method of claim 15, wherein members in a group exchange compensation for the interaction.

17. The method of claim 15, the compensation is financial, barter, or payment in kind.

18. The method of claim 16, wherein the compensation is based on are based on attributes of the interactions including at least one of a size of files transfer, a quality of a good, a quality of a service, a type of good, a type of server, and a member rating.

19. The method of claim 16, wherein the compensation is managed using a clearinghouse.

20. The method of claim 1 further comprising:
authenticating an identity of the requestor.

21. The method of claim 20, wherein the identity of the requestor is authenticated using a certificate.

22. The method of claim 1, wherein certificates are used to identify individuals in a group.

23. The method of claim 22, wherein each certificate within the certificates is associated with at least one of an IP address and an e-mail address.

24. The method of claim 11, wherein an existing member of the group can authorize a new member to the group.

25. The method of claim 11, wherein the member of the group can initiate a vote to exclude another member of the group.

26. The method of claim 11, wherein a duration of membership within the group is unlimited.

27. The method of claim 11, wherein a duration of membership within the group is based upon receiving a payment from the member.

28. The method of claim 11, wherein a duration of membership within the group is based upon a presence of selected attributes.

29. The method of claim 28, wherein t h e selected attributes include at least one of marital status, age, and interests.

30. The method of claim 11, wherein a duration of membership within the group is based upon at least one of contributions to the peer-to-peer data processing system and usage of the peer-to-peer data processing system.

31. The method of claim 11, wherein access to the group is controlled.

32. The method of claim 31, wherein the access is controlled using at least one of a password, payment of money, payment of services, and reference to a user preference.

33. The method of claim 1, wherein the request is an advertisement.

34. The method of claim 33, wherein the advertisement is targeted based on the preferences.

35. A data processing system comprising:
a bus system;
a communications unit connected to the bus system;
a memory connected to the bus system, wherein the memory includes a set of instructions; and
a processing unit connected to the bus system, wherein the processing unit executes the set of instructions to receive a request from a requestor; compare preferences within the request a policy to form a comparison, wherein the policy controls responses by the data processing system to the requests; and selectively respond to the request based on comparison.

36. A data processing system within a peer-to-peer network data processing system for managing processing of requests, the data processing system comprising:
receiving means for receiving a request from a requestor;
comparing means for comparing preferences within the request a policy to form a comparison, wherein the policy controls responses by the data processing system to the requests; and
selectively responding means for selectively responding to the request based on comparison.

37. The data processing system of claim 36, wherein the preferences provide parameters for which a response is desired.

38. The data processing system of claim 36, wherein the preferences provide parameters for which a response is not desired.

39. The data processing system of claim 36, wherein the requestor is an employee seeking to contact an employer.

40. The data processing system of claim 39, wherein the data processing system responds to the request if the preference information of the data processing system indicates that the data processing system is associated with an employer.

41. The data processing system of claim 36 , wherein the preferences identify a group associated with the requester and wherein the policy allows only interaction with members of a same group.

42. The data processing system of claim 36, wherein the preferences identify a group associated with the requestor and wherein the policy allows only interaction with members of a different group.

43. The data processing system of claim 36, wherein the preferences identify a group associated with the requestor and wherein the policy allows only interaction with members of selected groups of members.

44. The data processing system of claim 36, wherein the requester is a member of a group.

45. The data processing system of claim 44, wherein groups are based upon at least one of social interaction preferences, dating preferences, music preferences, media preferences, skills of a member, interest, geographic location, membership in an organization, consumption preferences, purchasing history, and expertise.

46. The data processing system of claim 44, wherein membership in the group is based on payment.

47. The data processing system of claim 36 further comprising:
generating means for generating an outgoing request, wherein the outgoing request includes a request for one of a chat session, instant messaging, or e-mail message.

48. The data processing system of claim 36, wherein the request is for interaction with one of a dating service, an information sharing service, a group buying service, instant messaging, electronic mail, distributing software, distributing software upgrades, distributing software fixes, an employment service, a music sharing service, a book sharing service, an image sharing service, and a travel service.

49. The data processing system of claim 48, wherein members in a group exchange compensation for the interaction.

50. The data processing system of claim 48, the compensation is financial, barter, or payment in kind.

51. The data processing system of claim 49, wherein the compensation is based on are based on attributes of the interactions including at least one of a size of files transfer, a quality of a good, a quality of a service, a type of good, a type of server, and a member rating.

52. The data processing system of claim 49, wherein the compensation is managed using a clearinghouse.

53. The data processing system of claim 36 further comprising:
authenticating means for authenticating an identity of the requester.

54. The data processing system of claim 53, wherein the identity of the requester is authenticated using a certificate.

55. The data processing system of claim 36, wherein certificates are used to identify individuals in a group.

56. The data processing system of claim 55, wherein each certificate within the certificates is associated with at least one of an IP address and an e-mail address.

57. The data processing system of claim 44, wherein an existing member of the group can authorize a new member to the group.

58. The data processing system of claim 44, wherein the member of the group can initiate a vote to exclude another member of the group.

59. The data processing system of claim 44, wherein a duration of membership within the group is unlimited.

60. The data processing system of claim 44, wherein a duration of membership within the group is based upon receiving a payment from the member.

61. The data processing system of claim 44, wherein a duration of membership within the group is based upon a presence of selected attributes.

62. The data processing system of claim 61, wherein the selected attributes include at least one of marital status, age, and interests.

63. The data processing system of claim 44, wherein a duration of membership within the group is based upon at least one of contributions to the peer-to-peer data processing system and usage of the peer-to-peer data processing system.

64. The data processing system of claim 44, wherein access to the group is controlled.

65. The data processing system of claim 64, wherein the access is controlled using at least one of a password, payment of money, payment of services, and reference to a user preference.

66. The data processing system of claim 36, wherein the request is an advertisement.

67. The data processing system of claim 66, wherein the advertisement is targeted based on the preferences.

68. A computer program product in a computer readable medium within a peer-to-peer network data processing system for managing processing of requests, the computer program product comprising:
first instructions for receiving a request from a requestor;
second instructions for comparing preferences within the request a policy to form a comparison, wherein the policy controls responses by the data processing system to the requests; and
third instructions for selectively responding to the request based on comparison.

69. The computer program product of claim 68, wherein the preferences provide parameters for which a response is desired.

70. The computer program product of claim 68, wherein the preferences provide parameters for which a response is not desired.

71. The computer program product of claim 68, wherein the requester is an employee seeking to contact an employer.

72. The computer program product of claim 71, wherein the data processing system responds to the request if the preference information for the data processing system indicates that the data processing system is associated with an employer.

73. The computer program product of claim 68 , wherein the preferences identify a group associated with the requester and wherein the policy allows only interaction with members of a same group.

74. The computer program product of claim 68, wherein the preferences identify a group associated with the requestor and wherein the policy allows only interaction with members of a different group.

75. The computer program product of claim 68, wherein the preferences identify a group associated with the requester and wherein the policy allows only interaction with members of selected groups of members.

76. The computer program product of claim 68, wherein the requestor is a member of a group.

77. The computer program product of claim 76, wherein groups are based upon at least one of social interaction preferences, dating preferences, music preferences, media preferences, skills of a member, interest, geographic location, membership in an organization, consumption preferences, purchasing history, and expertise.

78. The computer program product of claim 76, wherein membership in the group is based on payment.

79. The computer program product of claim 68 further comprising:
fourth instructions for generating an outgoing request, wherein the outgoing request includes a request for one of a chat session, instant messaging, or e-mail message.

80. The computer program product of claim 68, wherein the request is for interaction with one of a dating service, an information sharing service, a group buying service, instant messaging, electronic mail, distributing software, distributing software upgrades, distributing software fixes, an employment service, a music sharing service, a book sharing service, an image sharing service, and a travel service.

81. The computer program product of claim 80, wherein members in a group exchange compensation for the interaction.

82. The computer program product of claim 80, the compensation is financial, barter, or payment in kind.

83. The computer program product of claim 81, wherein the compensation is based on are based on attributes of the interactions including at least one of a size of files transfer, a quality of a good, a quality of a service, a type of good, a type of server, and a member rating.

84. The computer program product of claim 81, wherein the compensation is managed using a clearinghouse.

85. The computer program product of claim 68 further comprising:
fourth instructions for authenticating an identity of the requestor.

86. The computer program product of claim 85, wherein the identity of the requestor is authenticated using a certificate.

87. The computer program product of claim 68, wherein certificates are used to identify individuals in a group.

88. The computer program product of claim 87, wherein each certificate within the certificates is associated with at least one of an IP address and an e-mail address.

89. The computer program product of claim 76, wherein an existing member of the group can authorize a new member to the group.

90. The computer program product of claim 76, wherein the member of the group can initiate a vote to exclude another member of the group.

91. The computer program product of claim 76, wherein a duration of membership within the group is unlimited.

92. The computer program product of claim 76, wherein a duration of membership within the group is based upon receiving a payment from the member.

93. The computer program product of claim 76, wherein a duration of membership within the group is based upon a presence of selected attributes.

94. The computer program product of claim 93, wherein the selected attributes include at least one of marital status, age, and interests.

95. The computer program product of claim 76, wherein a duration of membership within the group is based upon at least one of contributions to the peer-to-peer data processing system and usage of the peer-to-peer data processing system.

96. The computer program product of claim 76, wherein access to the group is controlled.

97. The computer program product of claim 96, wherein the access is controlled using at least one of a password, payment of money, payment of services, and reference to a user preference.

98. The computer program product of claim 68, wherein the request is an advertisement.

99. The computer program product of claim 98, wherein the advertisement is targeted based on the preferences.
